(19) United States
(12) Patent Application Publication
(10) Pub. No.: US 2002/0113007 A1
(43) Pub. Date: Aug. 22, 2002

(54) Filter

(76) Inventor: Daniel J. Chiodo, Weston, FL (US)

Correspondence Address: OLTMAN, FLYNN & KUBLER, 915 MIDDLE RIVER DRIVE, SUITE 415, FORT LAUDERDALE, FL, 33304, US

(21) Appl. No.: 09/785,983

(22) Filed: Feb. 20, 2001

(51) Int. Cl. B01D 29/085

(52) U.S. Cl. 210/497.01

(57) ABSTRACT

A filter having an annular side wall and a circular bottom panel joined thereto and presenting a series of concentric annular horizontal steps at successively higher levels radially inward from its periphery for affecting the rate at which filtered liquid flows down through the filter.

### BACKGROUND OF THE INVENTION

1. Field of the Invention

This invention relates to a filter for straining liquids containing particles to be separated from the liquid, and particularly a coffee filter.

2. Prior Art

Filter assemblies for straining liquids containing finely dispersed particles therein commonly have a perforated filter basket with a disposable filter element, for example, of paper, inserted into the filter basket. Filters of this general type are inconvenient to use because of the need to have a supply of disposable filter elements available.

The prior art shows filters wherein a screen and filter frame are combined in various ways.

For example, U.S. Pat. No. 4,374,026 shows a basket filter with various filter or screen elements having their adjoining edges embedded in plastic. This filter, however, has the drawback that it is composed of several screen parts that must first be assembled and then embedded in plastic.

U.S. Pat. No. 4,822,055 shows a unitary injection molded filter wherein the filter screen and the supporting frame are molded as an integral part. This filter, however, has the drawback that a high degree of fineness of the filter is virtually impossible to obtaain since every hole in the filter screen must be molded into the screen during the molding process. Therefore, the filter according to U.S. Pat. No. 4,822,055 is unsuitable for filter applications wherein it is necessary to provide a high degree of fineness of the filter screen.

My U.S. Pat. Nos. 5,266,194 and 5,252,204 disclose unitary filter assemblies in which a support frame is molded to a separately formed when such a filter is positioned in the usual filter holder of the coffee maker filter.

### SUMMARY OF THE INVENTION

In accordance with the present invention, a filter is provided with a bottom panel of stepped configuration which, when the filter is in the usual filter holder or basket of a coffee maker, achieves a flow rate such that the filtered coffee has an acceptable strength, not too strong and not too weak. Preferably, the stepped configuration of the filter's bottom panel is in the form of concentric segments at successively higher levels radially inward across the bottom panel.

### BRIEF DESCRIPTION OF THE DRAWINGS

FIG. 1 is a perspective view of a filter in accordance with the present invention.

FIG. 2 is a top plan view of this filter;

FIG. 3 is a side elevation of the filter;

FIG. 4 is a bottom plan view of the filter;

FIG. 5 is a diametrical cross-section taken along the line 5-5 in FIG. 2; and

FIG. 6 is a section taken along the line 6-6 in FIG. 2 though the upper part of the filter.

Before explaining the disclosed embodiment of the present invention in detail it is to be understood that the invention is not limited in its application to the details of the particular arrangement shown and described since the invention is capable of other embodiments. Also, the terminology used herein is for the purpose of description and not of limitation.

### DETAILED DESCRIPTION OF THE INVENTION

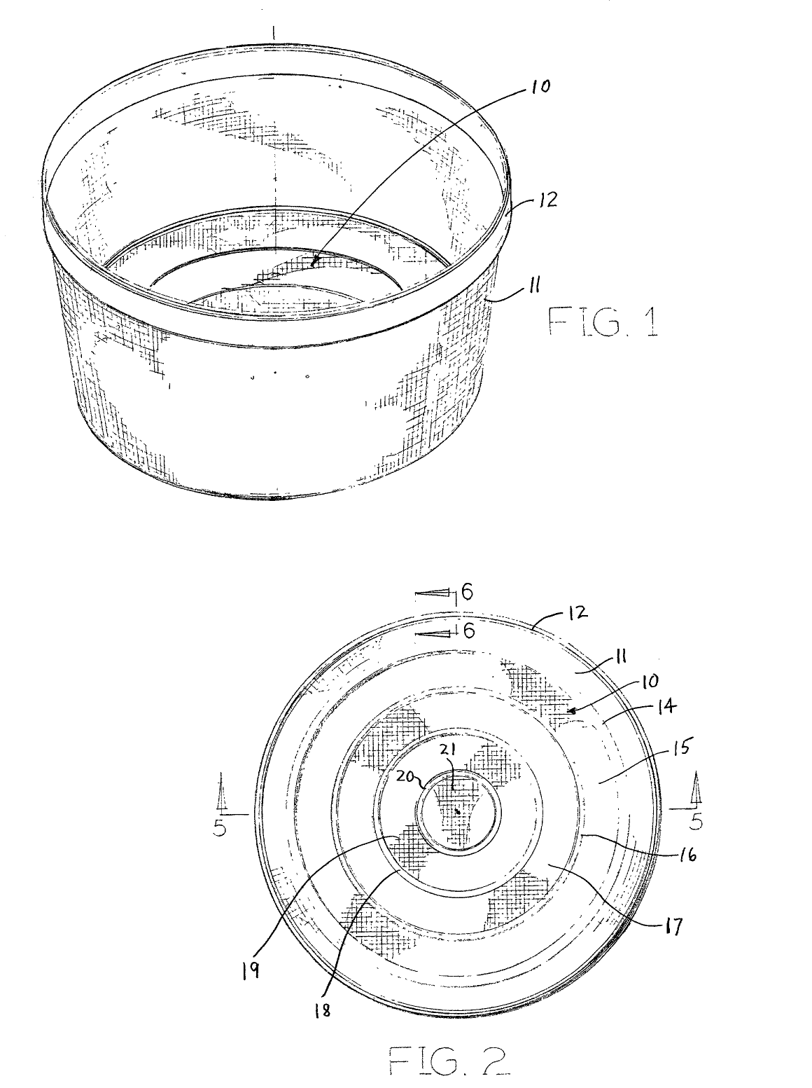

Referring to FIG. 1, in broad outline the filter of this invention has a bottom panel 10, an annular side wall 11 joined to the bottom wall at its periphery and extending upward from it and outward at a slight angle to form a frustum of a cone, and a plastic rim 12 overlying the top edge of side wall 11 and extending down a short distance across the outside and inside faces of the side wall (FIGS. 5 and 6). Preferably, the bottom panel 10 and side wall 11 are of stainless steel mesh or screening, without wires, of a suitable porosity for filtering coffee.

This filter is removably received snugly in the usual open-topped filter holder or basket of a coffee maker (not shown), which has a bottom wall with a central opening through which filtered coffee flows down into a receptacle.

In accordance with the present invention, the bottom panel 10 has a stepped configuration as shown in FIG. 5, which I have found results in coffee of the proper strength produced by the flow of hot water down through coffee grounds positioned in the filter on top of the bottom panel. In contrast, if the bottom panel 10 is flat, when such a filter is positioned in the usual filter holder of the coffee maker I have found that the coffee tends to be too strong because the liquid passes down through it too slowly. Also, if the bottom panel 10 is concavo-convex (with the convex face down), when such a filter is positioned in the usual filter holder of the coffee maker I have found that the coffee tends to be too weak because the liquid flows down through it too rapidly.

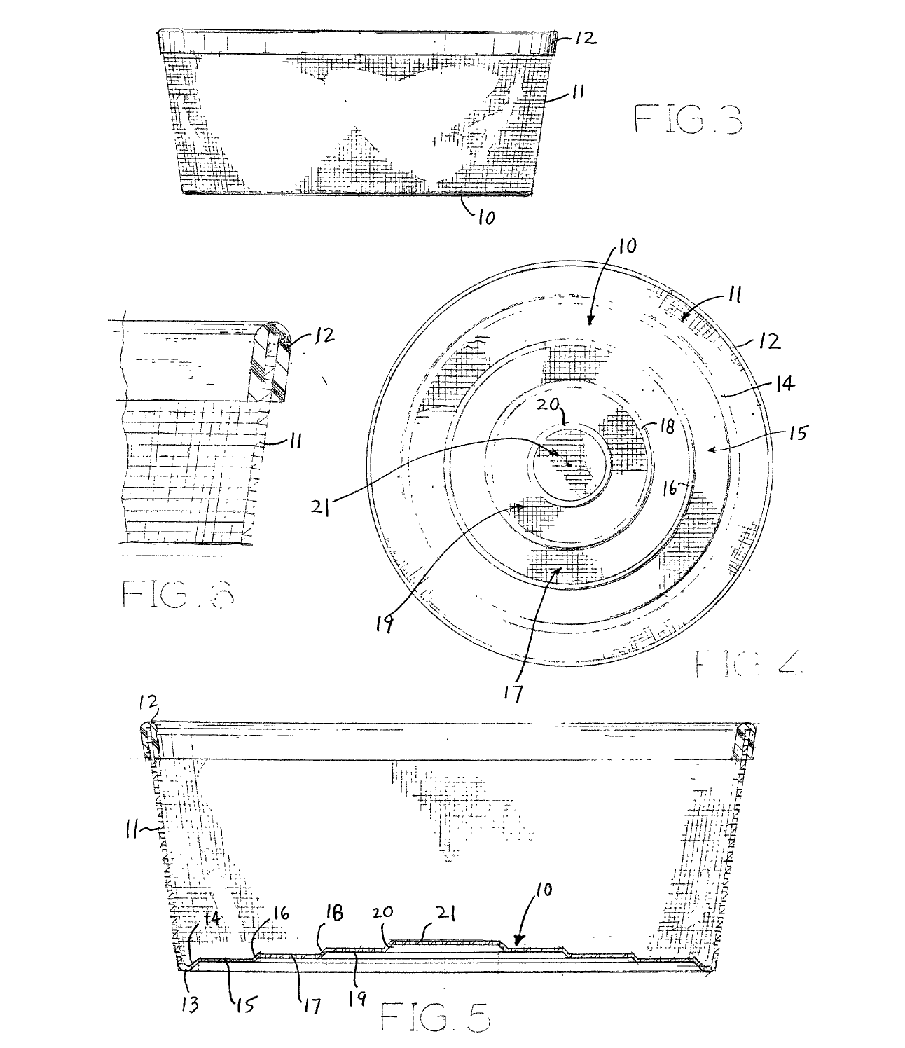

As shown in FIGS. 2 and 4, the bottom panel 10 of the present filter has concentric annular steps at successively higher elevations radially inward from the side wall 11. A rounded, downwardly projecting, annular corner 13 of the filter (FIG. 5) is formed at the juncture between its side wall 11 and its bottom panel 10. An upwardly and inwardly inclined annular connecting segment or frustoconical ring 14 connects the annular corner 13 to the circular outer edge of a first annular step 15 of the bottom panel. Step 15 extends horizontally when the filter is in its operative, upright position, as shown in FIG. 5 (seated in the usual filter holder of the coffee maker). A second upwardly and inwardly inclined annular connecting segment or ring 16 connects the circular inner edge of step 15 to the circular outer edge of a second annular step 17, which extends horizontally when the filter is upright. A third upwardly and inwardly inclined annular connecting segment or ring 18 connects the circular inner edge of step 17 to the circular outer edge of a third annular step 19, which extends horizontally when the filter is upright. A fourth upwardly and inwardly inclined annular connecting segment or ring 20 connects the circular inner edge of step 19 to the circular outer edge of a center segment 21, which extends horizontally when the filter is upright.

It will be apparent that in the operative position of the filter the center segment 21 is at a slightly higher elevation than the smallest diameter annular step 19, and that the successively larger diameter annular steps 15 and 17 are at successively lower levels.

While the preferred embodiment of the invention has concentric annular steps as the portions of the bottom panel which are at different levels to provide the desired flow rate of filtered coffee, it is to be understood that a different configuration of these different level portions of the bottom panel may be provided, if desired.

I claim:

1. A filter for separating a fluid and particles immixed in the fluid, comprising a screen having a bottom panel and an annular side wall extending up from said bottom panel around its periphery, said bottom panel having different portions thereof at different levels when the filter is in an upright, bottom-down position.

2. A filter according to claim 1, wherein said different portions of said bottom panel are concentric and arranged at successively higher levels inward from the periphery of said bottom panel.

3. A filter according to claim 1, wherein said side wall and said bottom panel form a downwardly projecting rounded annular corner at the periphery of the bottom panel, and said different portions of the bottom panel are concentric annular horizontal steps at successively higher elevations inward from said annular corner.

4. A coffee filter comprising a circular bottom panel and a frusto-conical side wall extending upward and outward from the periphery of said bottom panel, said side wall and said bottom panel forming a downwardly projecting rounded annular corner at the periphery of the bottom segment, said bottom panel presenting a plurality of annular horizontal steps of successively smaller diameter radially inward from its periphery and a circular horizontal center segment radially inward from the smallest of said annular steps, and said bottom panel presenting a plurality of concentric frusto-conical rings connecting said annular steps and said center segment in succession radially inward across the bottom panel.
